(19) United States
(12) Patent Application Publication
(10) Pub. No.: US 2014/0304993 A1
(43) Pub. Date: Oct. 16, 2014

(54) DUAL SAFETY FEATURED UTILIY KNIFE/BOX CUTTER WITH FAST BLADE CHANGE DEVICE

(71) Applicant: Eddie Rafii, Laguna Niguel, CA (US)

(72) Inventor: Eddie Rafii, Laguna Niguel, CA (US)

(21) Appl. No.: 13/764,907

(22) Filed: Apr. 16, 2013

(51) Int. Cl. B26B 5/00; B26B 29/02

(52) U.S. Cl. CPC B26B 5/005; B26B 29/02
USPC 30/122; 30/164; 30/330

(57) ABSTRACT

A dual safety utility knife having a safety guard positioned next to the cutting blade preventing accidental injuries when the tip of the knife accidentally contacts human bodies. A spring keeps pushing out the safety guard to cover the side of the cutting blade at all times. The safety guard moves back inside the knife shell only when the tip of the knife pressed against hard objects for cutting. The safe guard doesn't move back inside the knife shell when the knife tip pressed against soft objects such as skins and mussels. Additional safety feature keeps locking the safety guard from movements at all times for extra safety protection. The safety guard is released only when the safe release button manually pushed in.

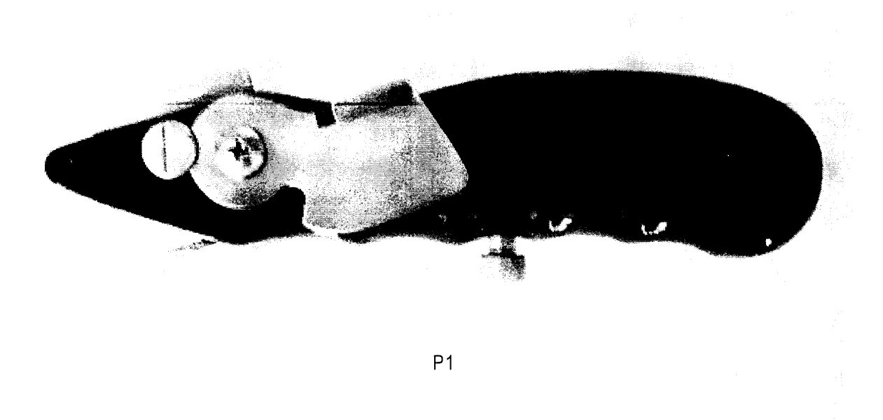

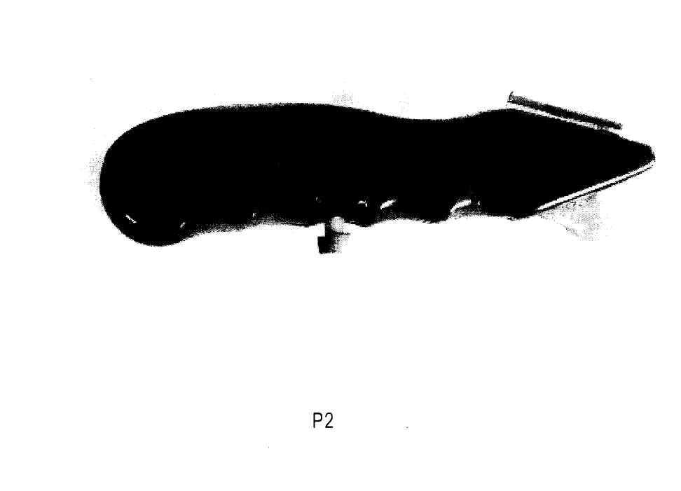

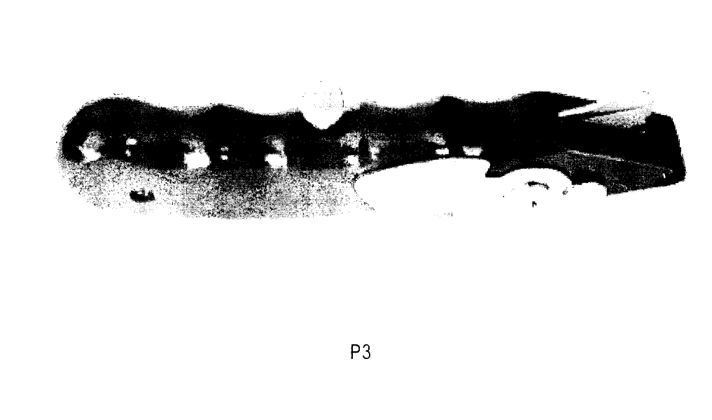

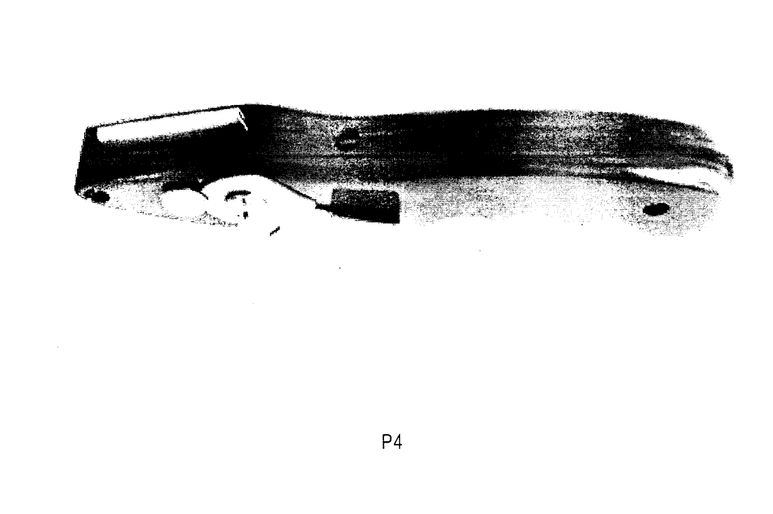

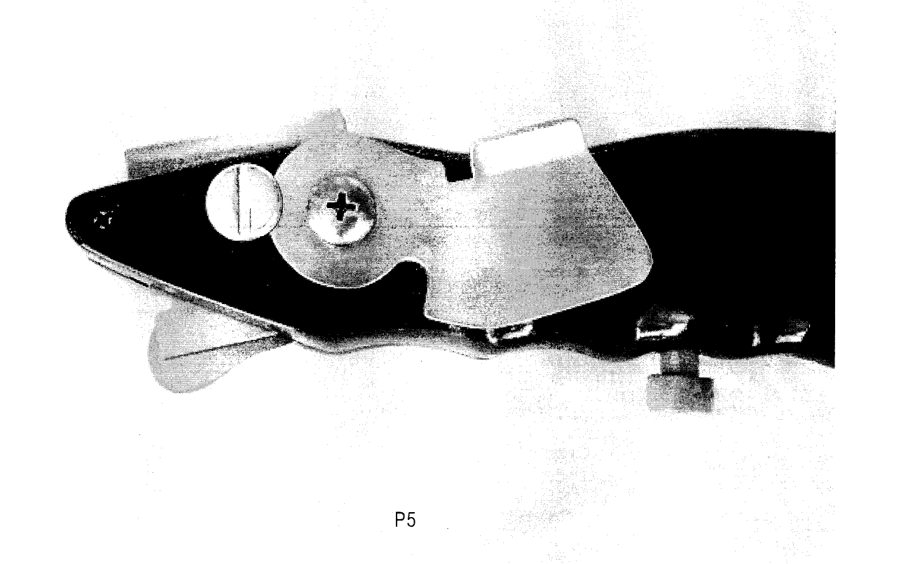

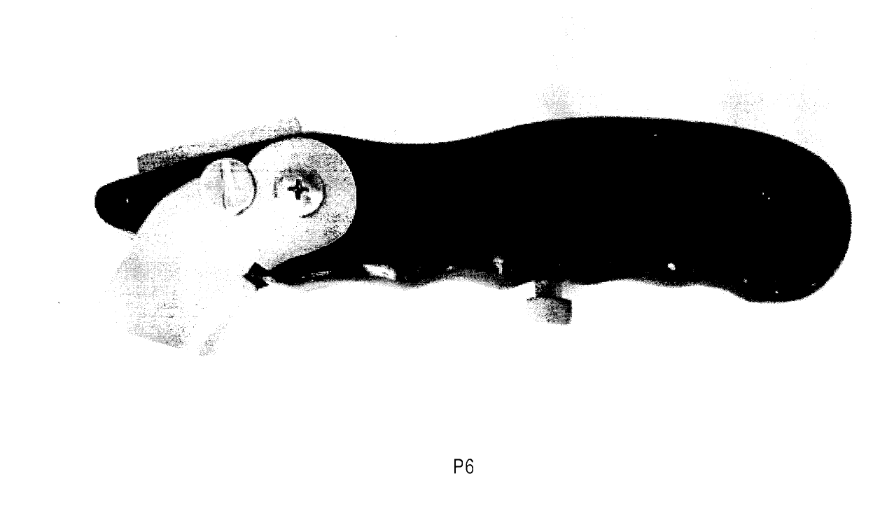

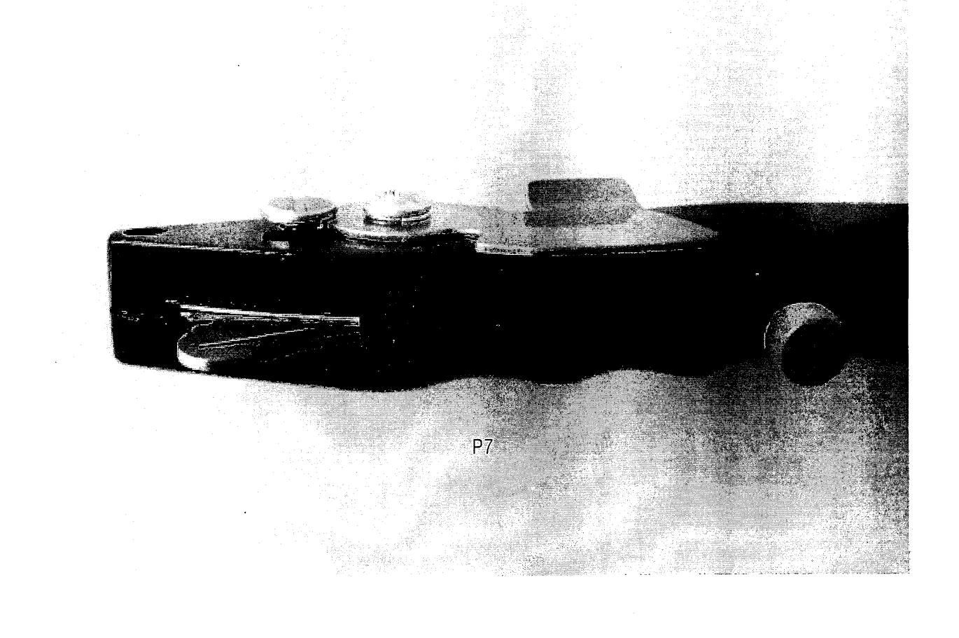

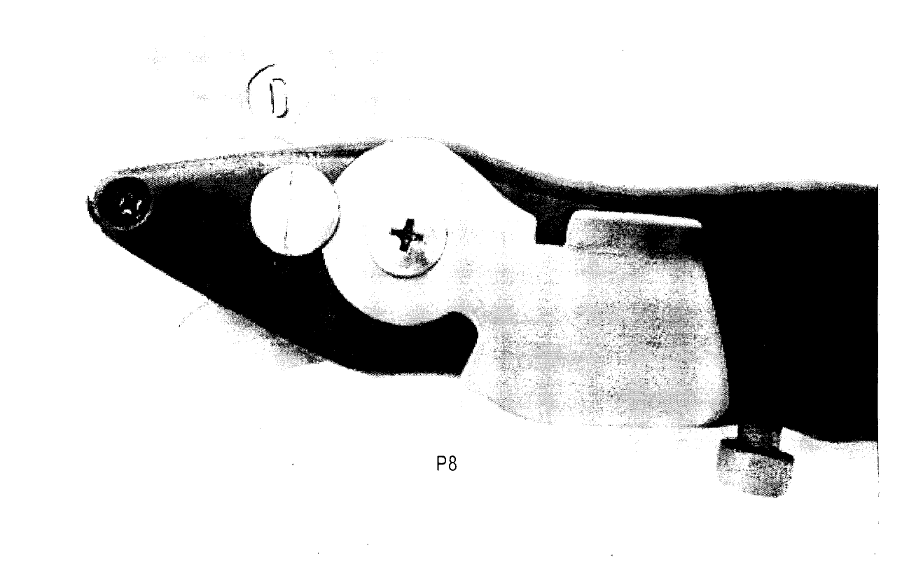

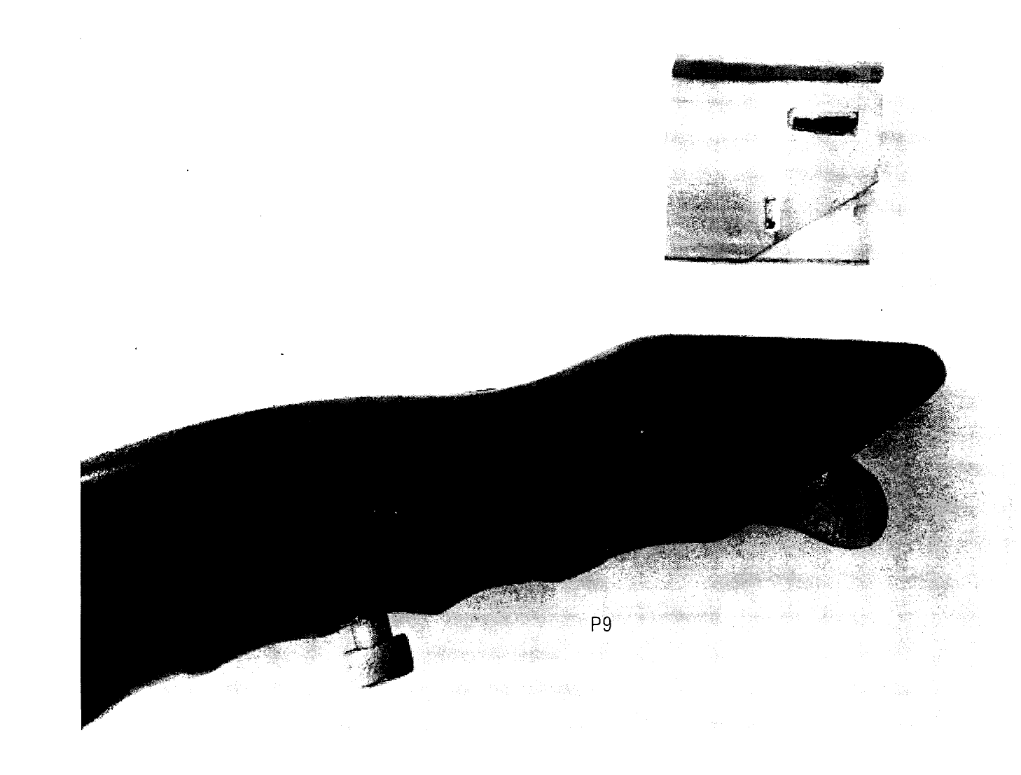

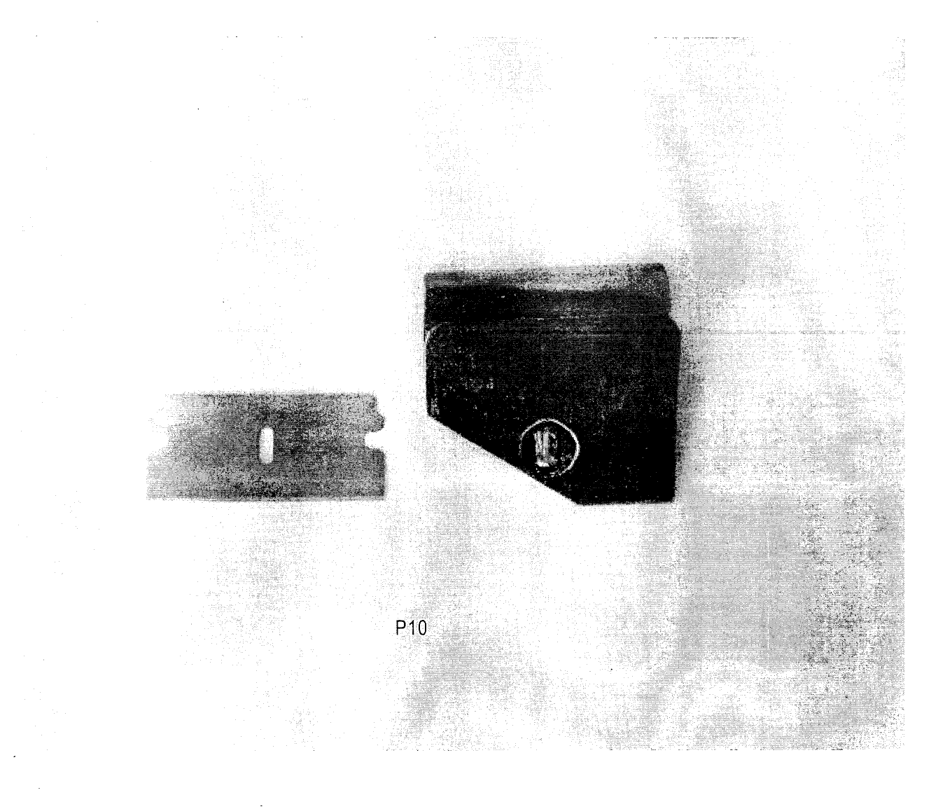

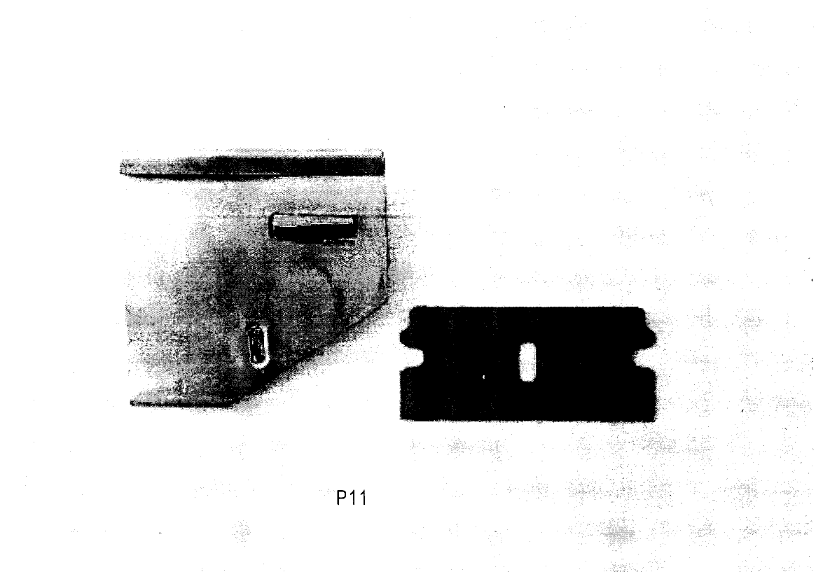

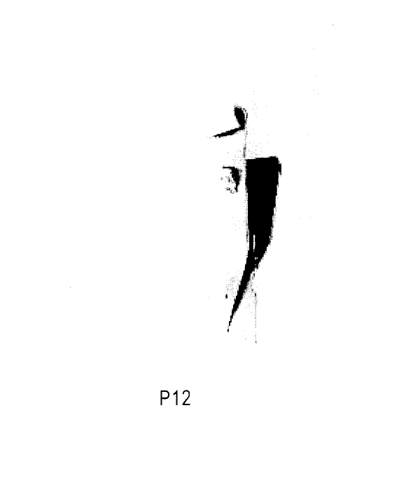

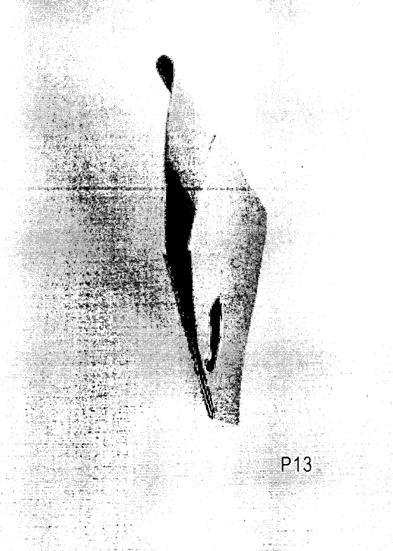

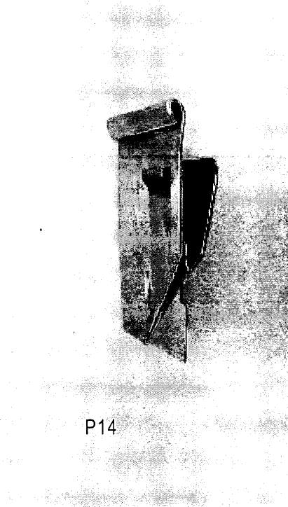

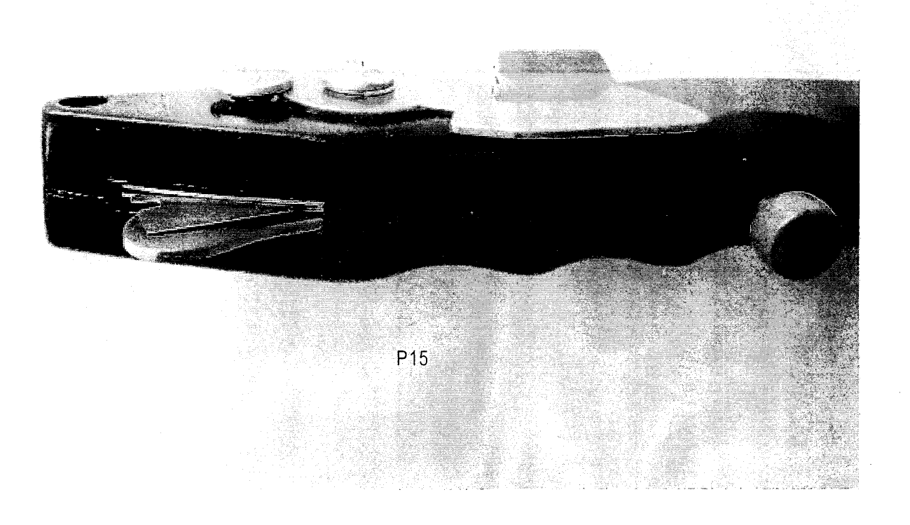

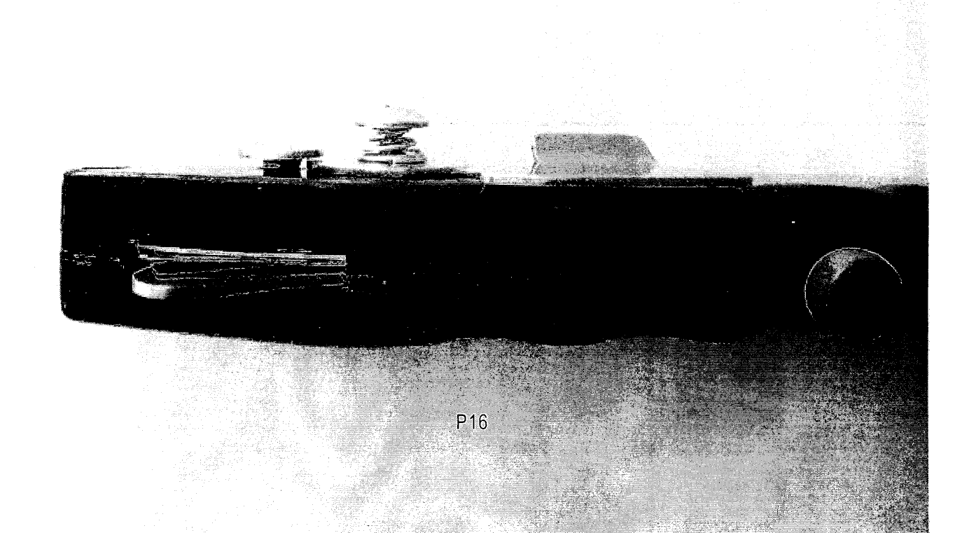

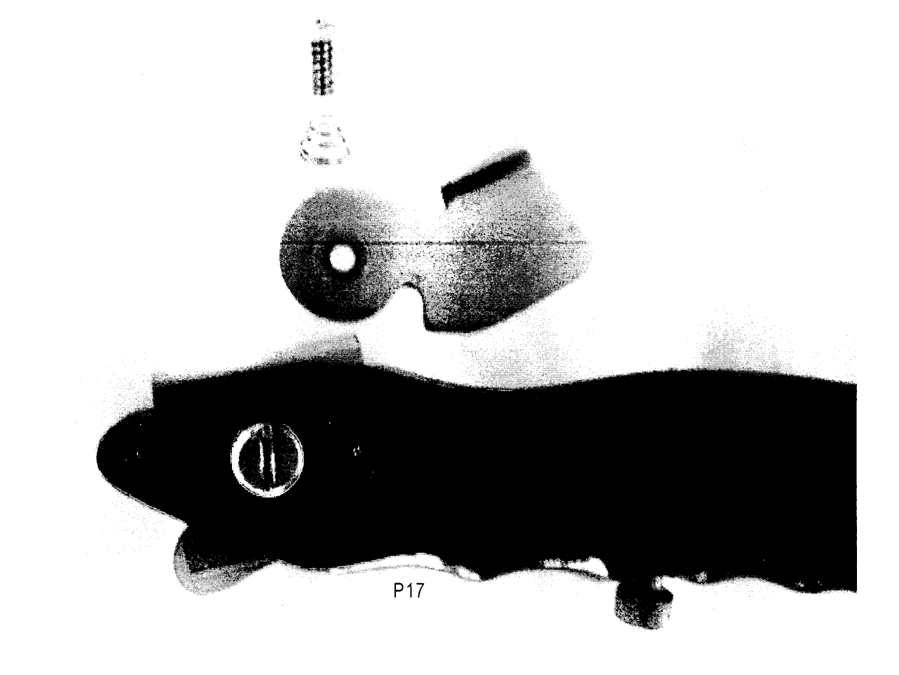

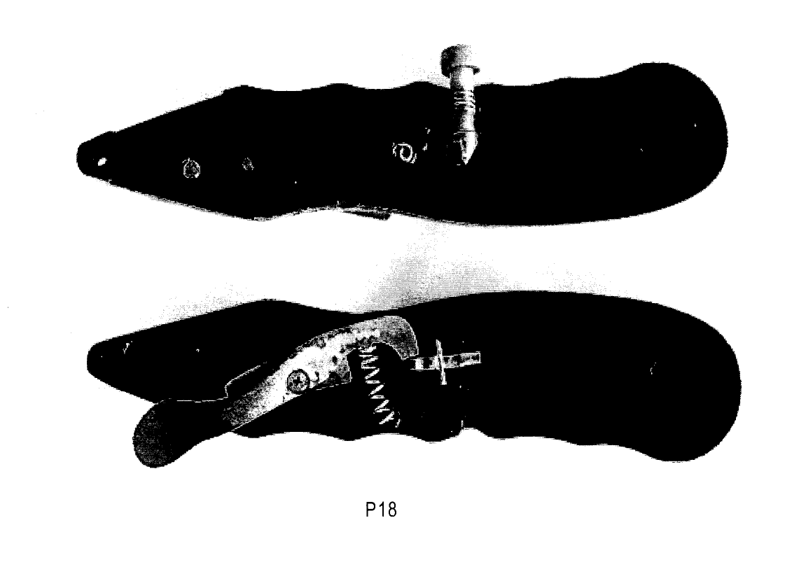

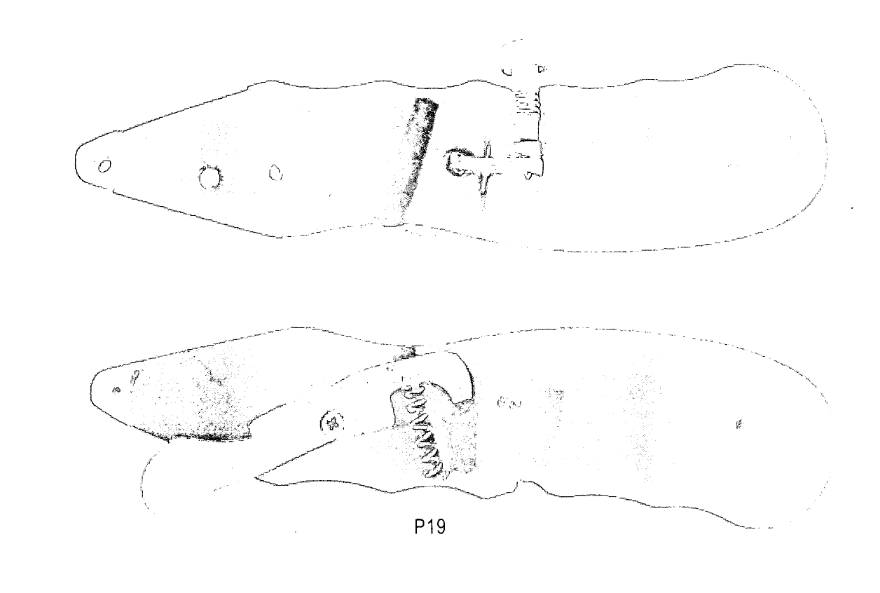

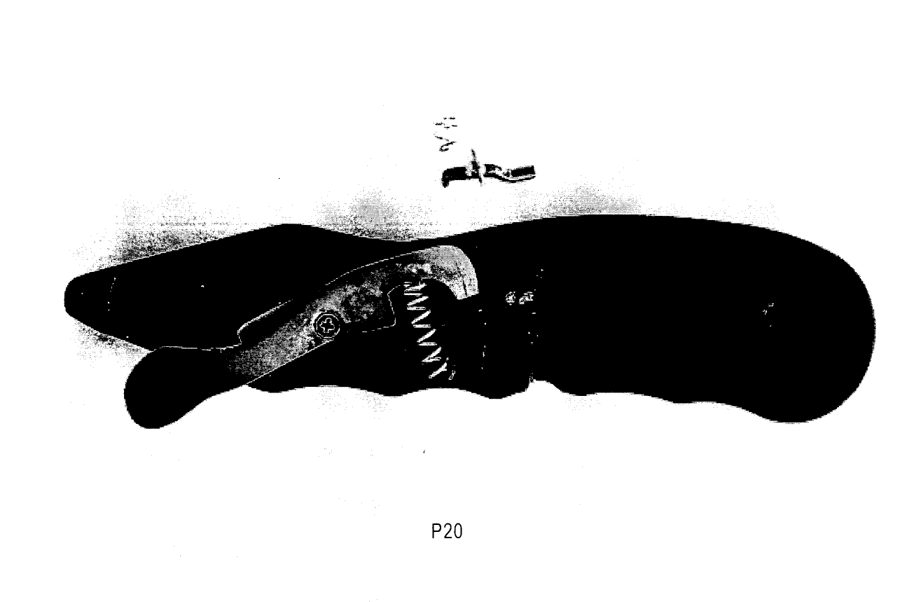

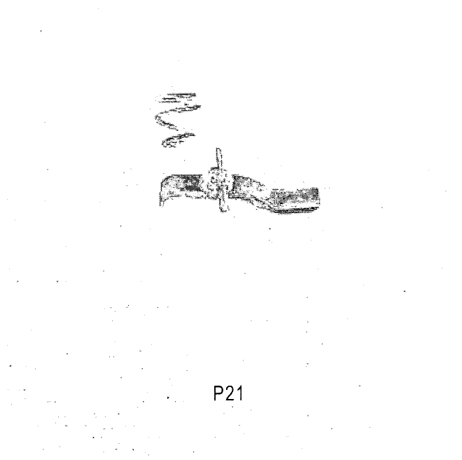

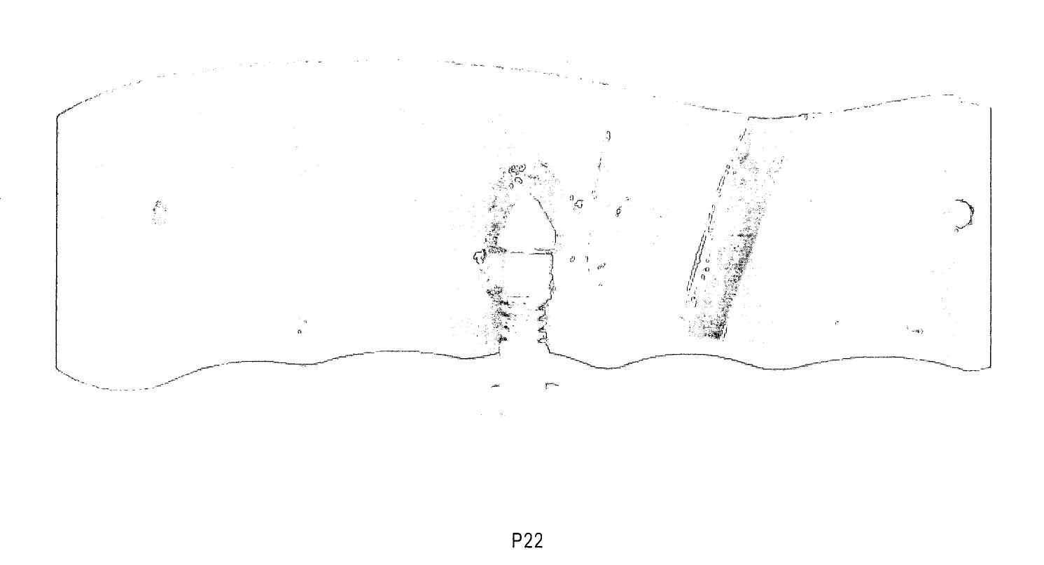

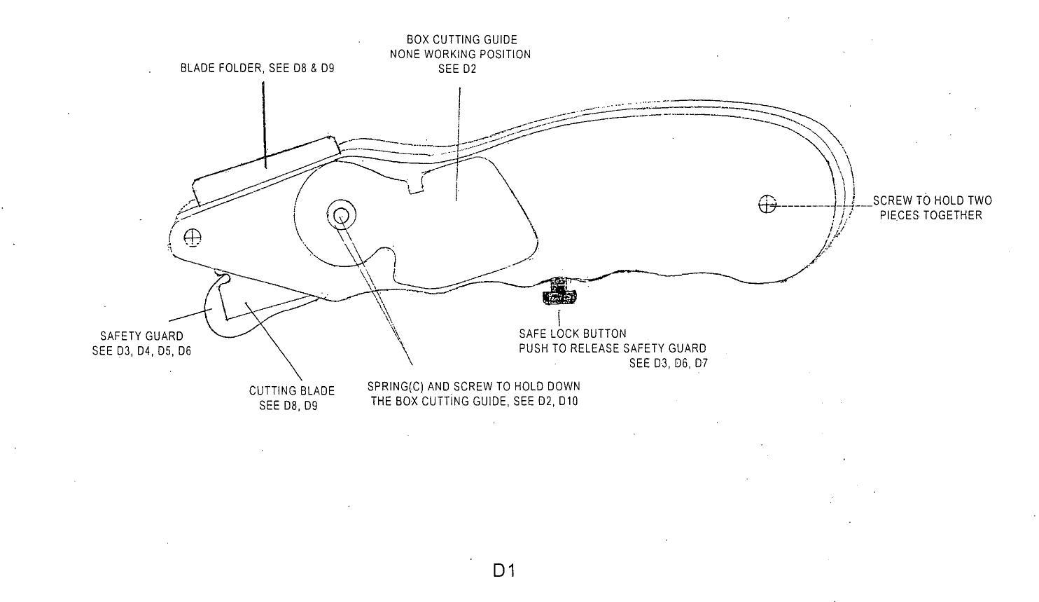

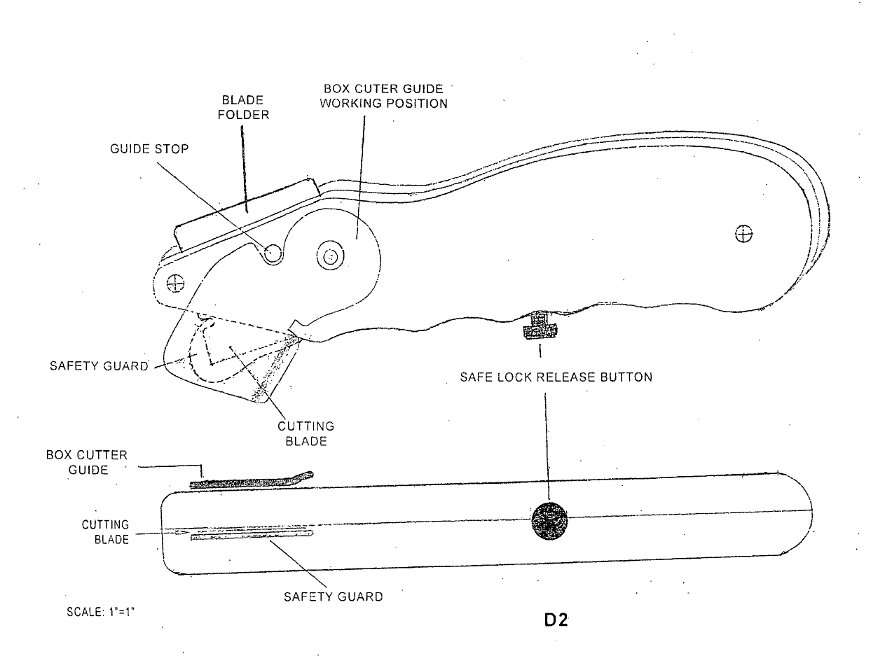

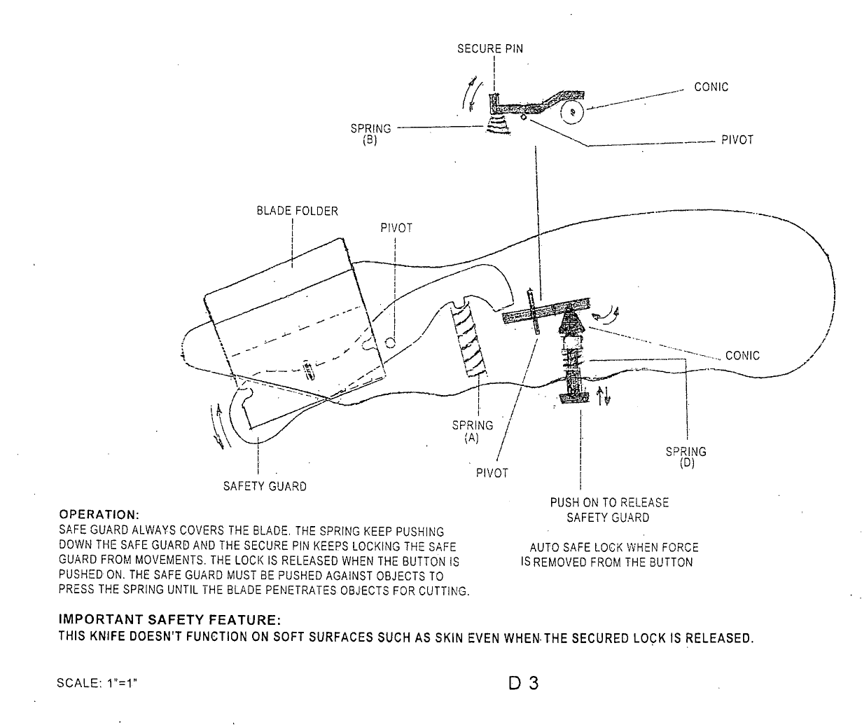

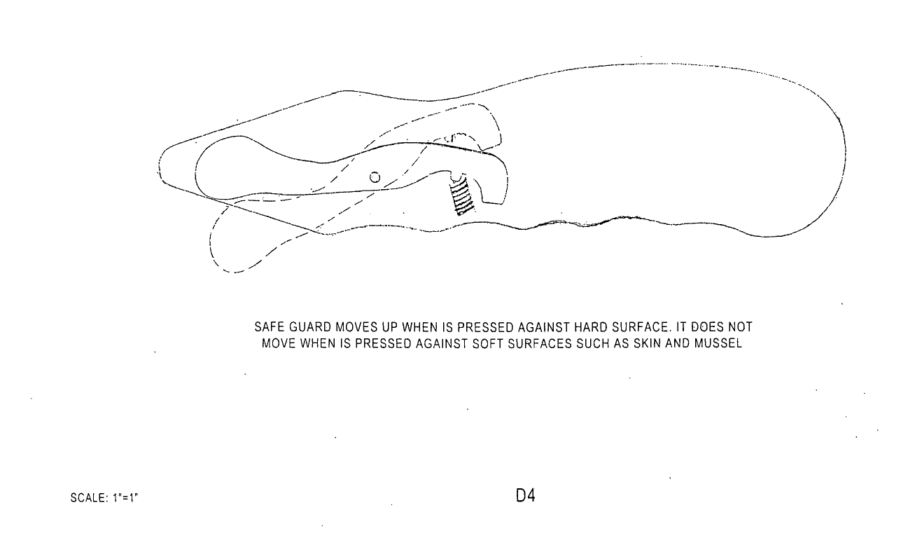

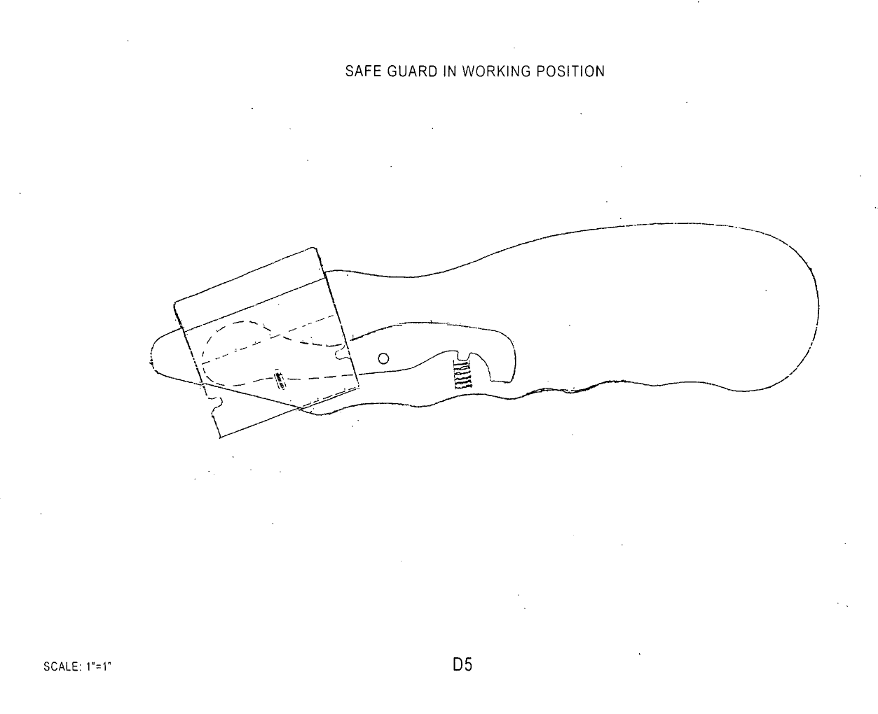

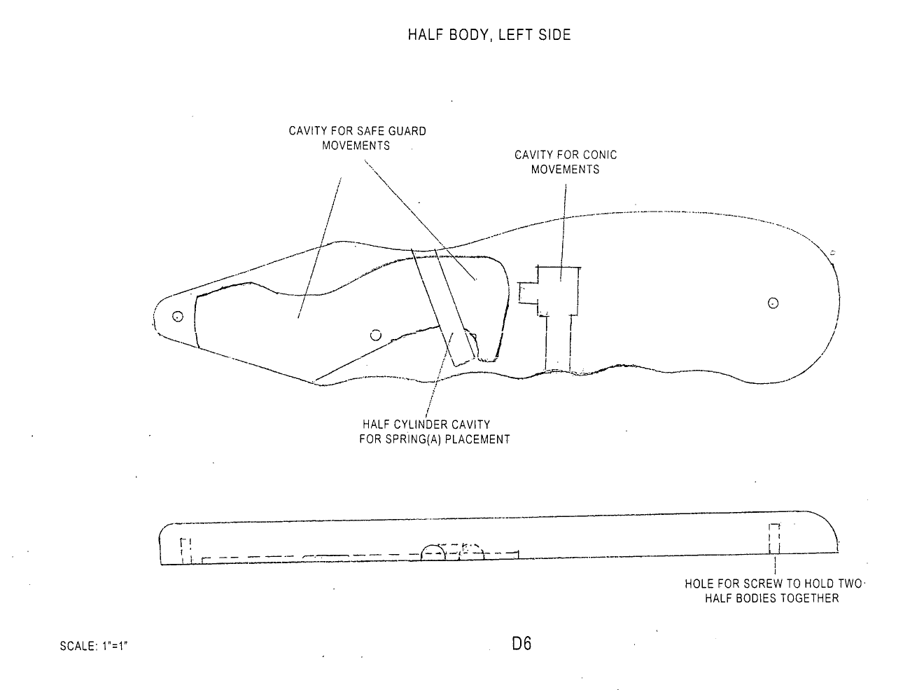

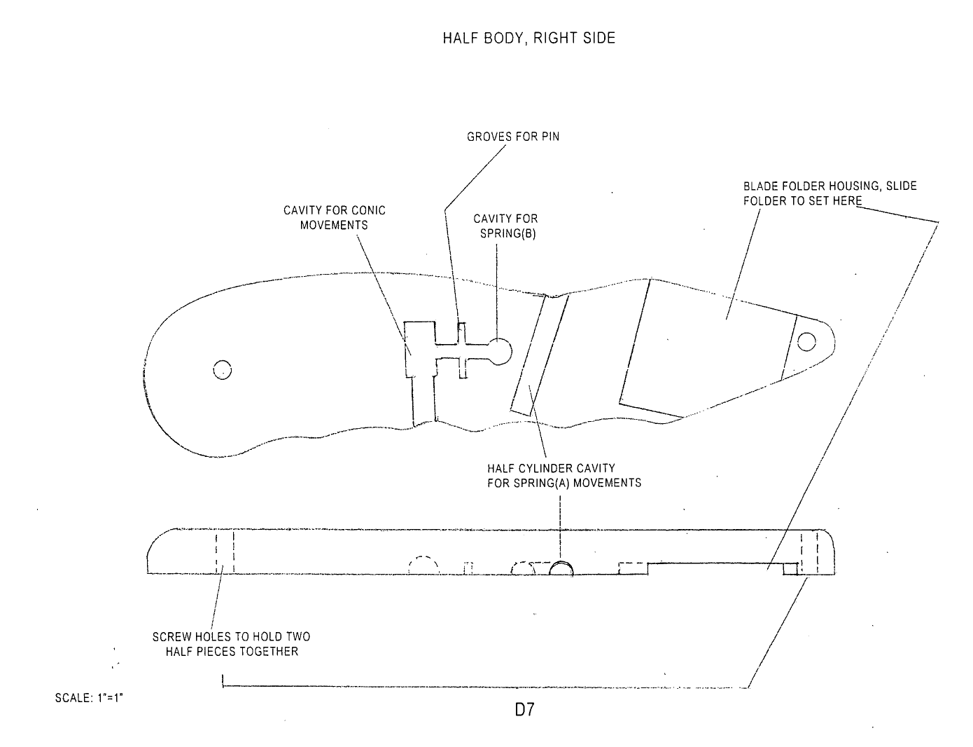

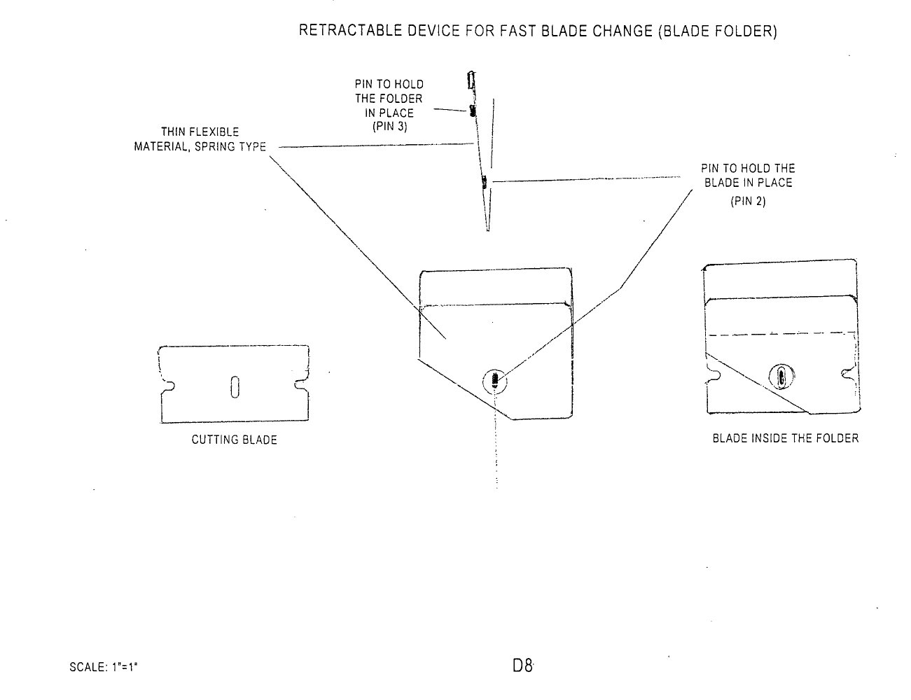

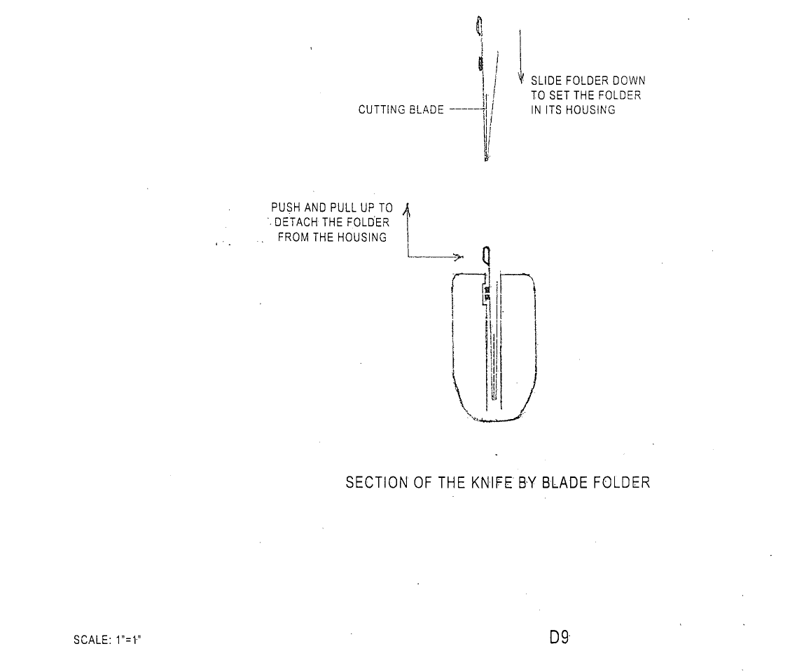

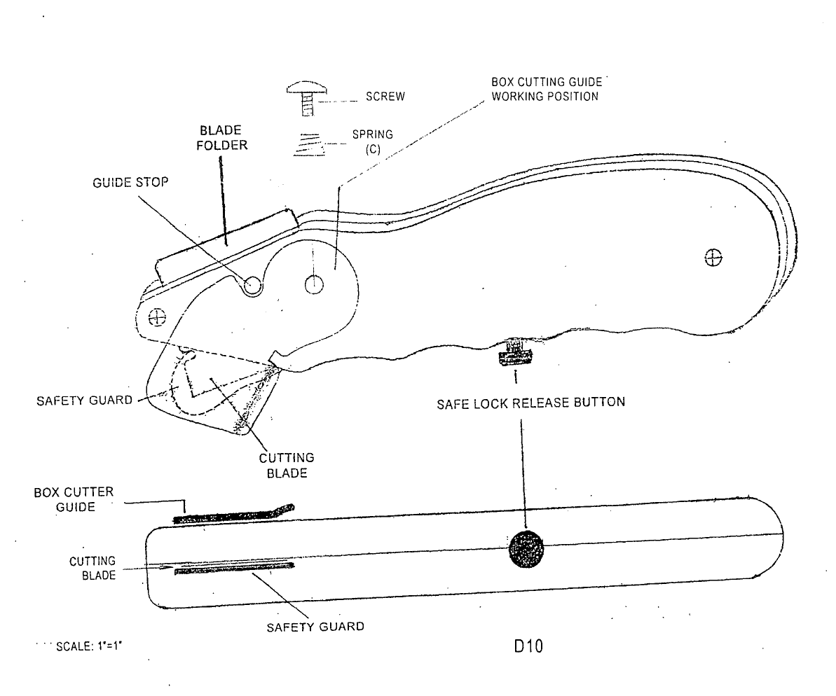

A box cutting guide allows cutting the top of the boxes with an even straight line.

A blade folder is provided for fast blade change.

A combined utility knife and box cutter with dual safety features including the fast blade change device.

A hand-held tool for cutting objects such as: cartons, boxes, cardboards, thin plastic sheets, drywalls and for general household use, contractors and specially used in stores and warehouses for opening boxes and cutting cartons.

A safe utility knife, a safe box cutter knife, a safe lock as a secondary security feature and a fast blade change device all in one

This hand tool works like a utility knife and a box cutter. The box cutting guide allows an evenly cut of top of the boxes at a parallel line with top of the boxes. The box cutting guide could be folded along the knife handle when is used as the utility knife.

There is a safety guard next to the cutting blade that prevents accidental injuries. The safety guard slides inside the knife body when the knife is pressed against the objects and the mechanism allows a safe cut. The guard doesn't slides inside the knife body when is pressed against soft objects such as skins and mussels.

Beside the above safety guard there is a safe lock system that is provided to keep the safe guard locked at all times. There is a release button provided on the knife handle that must be pushed in to unlock the safety guard and let the safety guard slides inside the knife shell and allows the cutting blade to function.

The safe guard doesn't slide inside the knife body to allow cuts on soft objects even when the safe lock is released. The force of the safety guard spring prevents safety guard movements when the tip of the knife is in contact with soft objects such as skins, mussels and foams. The safety guard must slides inside the knife body to free the blade for cutting.

This knife doesn't function on soft objects such as skins and mussels.

A new simple device named blade folder provides fast blade change. It looks like a folder made of thin flexible steel plate that is open about fifteen degrees, a thin blade inserts inside the folder, a pin (pin 2) inside the folder holds the blade in place. The folder slides in the housing provided in the knife body and a pin (pin 3) at outside of the folder holds the folder in place. A push and pull needed to slides out the folder, the folder that is open about fifteen degrees allows a fast blade change. The folder is closed and holds the blade when the folder is placed in its housing.

1. A combination of utility knife and box cutter:
a hand tool for cutting objects such as: cartons, boxes, cardboards, thin plastic sheets, drywalls and for general household use, contractors and specially used in stores and warehouses for opening boxes and cutting cartons.
a utility knife and box cutter, both in one unit;
a utility knife that instantly could be converted to a box cutter knife by quick unfold of the box cutting guide and could be instantly back to utility knife by folding the guide along the knife handle.
a box cutting guide, a pivot, a spring and a stop pin is to allow cuts on top of the boxes with an even distance of the top of the box in a straight line.
a spring keeps pushing down the guide to hold the guide in place along the knife handle when the tool is used as utility knife.
a spring and a stop pin to hold in place the guide when is used as box cutter

2. A thin blade to cut objects easily.
a blade like razor blade that needs less force to cut objects rather than usual utility knife blades that require more force for cutting.

3. An auto safe guard:
an auto safety guard to prevent the accidental injuries;
a piece of flat metal about 1/20 of an inch thick shaped like goose neck and installed next to the blade. The safety guard moves parallel with the blade.
a pivot allows the guard to slides back and force next and parallel to the blade.
a spring keeps pushing the safety guard to outside and covers the side of the blade at all times.
The only time safety guard slides back in the body of the knife and allows cutting is when the tip of knife is pressed against objects. The safe guard slides back to its position when the tip is remove from the objects.
safety guard do not slides in the body of the knife when is pressed against soft objects such as skin and mussels.

4. A knife with a mechanism that doesn't function for cutting soft objects such as skin, mussels and foams;
the force of the coil spring keeps the safety guard in place when the tip of the knife is pressed against soft object such as mussels and skins. The cutting objects must be hard enough to press the spring and push the safety guard into the knife body. There will be no cutting if the safety guard remains in its guarding position.

5. A safe lock as a secondary security device:
a safe lock as a secondary security device keeps the safety guard locked at all times to prevent injuries in case of accidental hard press of the knife tip on human bodies;
a security pin with a pivot and a spring keeps the safety guard locked at all times.

6. A safe lock button to manual unlock the knife:
a release button along with a spring and the conic end shaft moving in a cylinder, unlocks the safety guard by pressing the spring behind the security pin.
the safety guard doesn't slide to release the blade for cutting unless the security pin moves back and releases the safety guard, this only happens when the safe lock button is pushed manually.

7. A knife that doesn't cut when pressed and pulled against objects until the safe lock is released by manual push on the released button.

8. A knife that doesn't cut soft objects even when the safe lock is released in case of accidental push on release button.

9. A fast blade change system:
a blade folder with a simple mechanism for fast blade change;
a thin flexible flat steel (spring type) shaped like a folder, a half punched pin to hold the blade in place and another pin in the back of folder to hold in place the folder in the housing provided in the body of the knife.
The folder slides in the housing provided in the body of the knife and a pin on the side of folder holds it in place. The folder slides out by pushing and pulling the top of the folder.
The thin blade inserts inside the folder and the half punched pin holds the blade in place.
replacing the blade: the folder is open about fifteen degrees when it's not in its housing and the blade could be replaced easily.
quick blade change in a few seconds: push and pull the folder, remove the used blade, insert new blade and slide the folder in its housing.
